(19) United States
(12) Patent Application Publication
(10) Pub. No.: US 2009/0288845 A1
(43) Pub. Date: Nov. 26, 2009

(54) FIRE EXTINGUISHING APPARATUS

(76) Inventors: James R. Belford, Pasadena, MD (US); J. Paul Kingston, Pasadena, MD (US)

Correspondence Address: LAUBSCHER & LAUBSCHER, P.C., 1160 SPA ROAD, SUITE 2B, ANNAPOLIS, MD, 21403, US

(21) Appl. No.: 12/123,759

(22) Filed: May 20, 2008

(51) Int. Cl. A62C 35/00

(52) U.S. Cl. 169/15

(57) ABSTRACT

A foam type fire extinguishing apparatus includes a selector which is operable to produce selected constant air flows for mixing with foam to provide variations in foam consistency and strength in accordance with the type of foam agent being used and the type of fire to be extinguished. The selector has a plurality of outputs with tunable valves connected with each output except for a first output. Each valve is adjusted to provide a different flow rate. By operating the selector to choose the appropriate output, different air flows are provided for mixture with the foam.

### BACKGROUND OF THE INVENTION

While most fires are fought with water, certain types of fires are more quickly extinguished with foam. These includes fires fueled by accelerants such as gasoline and fires of certain materials such as plastic Class B fires and ordinary combustible Class A fires. There are a number of manufacturers of foam products which are adapted to be mixed with water and air to produce the foam. Each product has its own characteristics, with some being more suitable for certain types of fires. Depending on the type of foam, the quantity of water mixed with the foam, and the amount and flow of air used, the different types of foam that can be produced from fire extinguishing apparatus include wet foam, dry foam, light foam, heavy foam, and foams with different flow rates, coverage, penetration, and agents.

The present invention relates to a fire extinguishing apparatus which is adjustable to provide a variety of predetermined fire extinguishing agents, all with consistent characteristics, in accordance with the type of fire to be extinguished and with the type of foam agent being used.

### BRIEF DESCRIPTION OF THE PRIOR ART

Fire fighting foam discharge devices are well-know in the patented prior art as evidenced by the US patents to Bundy U.S. Pat. No. 4,981,178 and Crawley U.S. Pat. No. 6,733,004. The Bundy patent, for example, discloses a device wherein water, a surfactant, and compressed air are delivered to a mixing chamber to produce a foam discharge. The volume of water and air are varied to achieve a desired character of foam discharge. Crawley discloses a device for generating foam used to extinguish fires. The device includes a source of compressed air, a liquid pump, an injector in the supply line to the liquid pump for supplying a foaming agent, a mixer for mixing the compressed gas, liquid, and foaming agent, and a control valve for controlling the rate of flow of the liquid in the supply line. While such devices normally operate satisfactorily, it is difficult to produce consistent foam results because the volume of water and air is manually controlled by an operator via control valves and regulators as well as by control of the speed of an engine which controls water pressure and air volume.

The present invention was developed in order to overcome these and other drawbacks of prior foam discharge devices by providing a fire extinguishing apparatus with predetermined air flow characteristics which are selected by the operator in accordance with the foam agent being used and with the type of fire to be extinguished.

### SUMMARY OF THE INVENTION

The fire extinguishing apparatus according to the invention includes a foam supply, an air supply, and a device for mixing the air and foam to form a primary air and foam mixture according to the type of fire to be extinguished. The mixing device includes an air flow regulator connected with the air supply for controlling the flow of air. The air flow regulator includes a selector having a plurality of outputs of constant air flow and at least one adjustable valve connected with one of the selector outputs to adjust the flow from the selector output. The selector is operated to provide constant air flows of different velocity to the mixing device to maximize the efficiency of the primary air and foam mixture in accordance with the type of foam agent from the foam supply.

The fire extinguishing apparatus further includes a balancing regulator for controlling the pressure of the air supply to match that of the foam supply. The foam supply includes a foam injection pump which mixes a foam agent and water from water supply. The water supply includes a water tank and a recirculating water pump which provides water under pressure to the foam injection pump. A primer valve is connected with the air supply and the water supply for priming the recirculating water pump.

In an alternate embodiment of the invention, a secondary foam supply is connected with the output of the mixing apparatus for combining secondary foam with the primary air and water mixture from the mixing device.

### BRIEF DESCRIPTION OF THE FIGURES

Other objects and advantages of the invention will become apparent from a study of the following specification when viewed in the light of the accompanying drawing, in which:

FIG. 1 is a schematic diagram of the fire extinguishing apparatus according to the invention; and

FIGS. 2 and 3 are schematic diagrams of the primer valve in the pump and primer modes, respectively.

### DETAILED DESCRIPTION

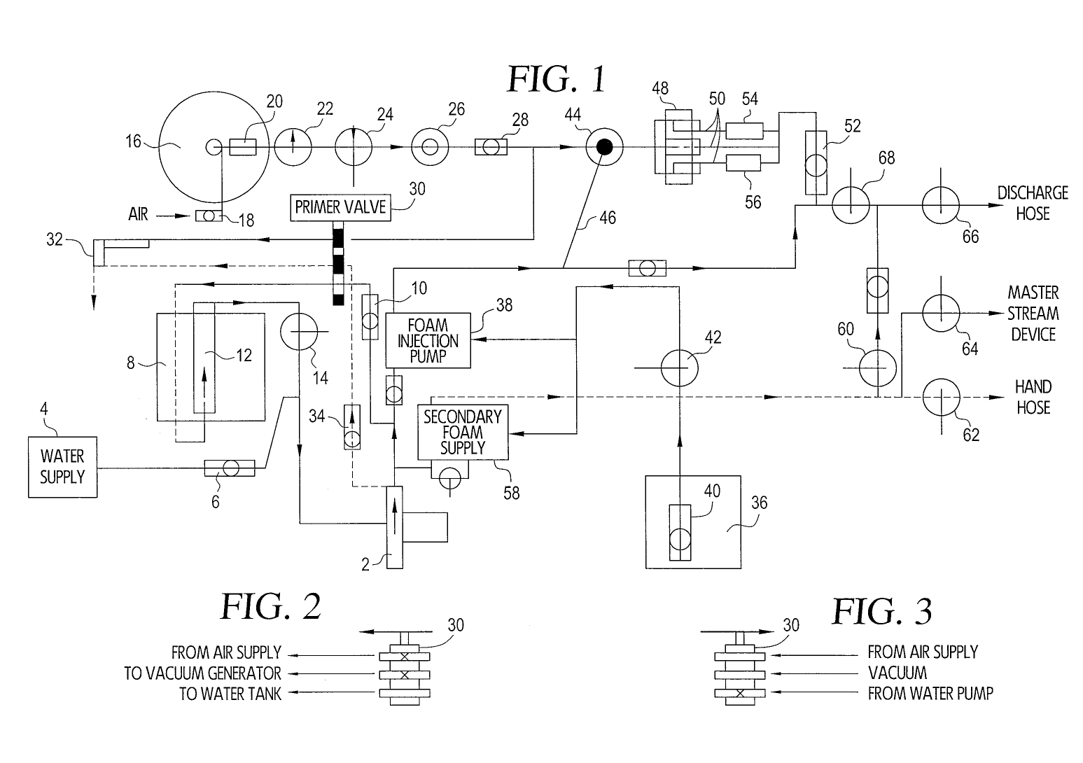

Referring to FIG. 1, the fire extinguishing apparatus according to a preferred embodiment of the invention will be described. The apparatus includes a water supply circuit, an air supply circuit, and a foam supply circuit. The supply lines are illustrated by solid lines, and the dashed lines show those lines in which no pressure is created. The water supply circuit includes a water pump 2 which may or may not be capable of drawing water from an exterior water supply 4 such as a pond or swimming pool via a check valve 6. In lieu of a pump, other sources of pressure may be utilized. The water is delivered to a water tank 8 via a check valve 10. The water tank includes a water pickup 12 which serves as a jet pump to increase the water pressure recirculated to the pump 2. A tank-to-pump valve 14 separates the water tank from the pump, thereby creating a draft used to draw water from the supply 4 to the pump 2 as the water in the tank is depleted.

The air supply circuit includes a tank 16 which contains air under pressure. Air is delivered to the tank via a fill port 18. The air in the tank is preferably at a pressure on the order of 5000 psi. In lieu of the air tank, an air compressor can be utilized as is known to people of ordinary skill in the art. A line regulator 20 reduces the pressure of the air to approximately 2500 psi, and a pressure gauge 22 indicates the pressure of the air at that location in the apparatus. A valve 24, a second regulator 26, and a check valve 28 cooperate to further reduce the air pressure to approximately 125 psi. The pressurized air is delivered to a primer valve 30 to assist with priming the water circuit. More particularly, the primer valve has three lines or passages therein. The bottom line is for recirculating water from the water pump 2 to the water tank 8. The top line delivers air from the air circuit to a vacuum generator or primer pump 32. The vacuum generator includes a venturi device. As air is exhausted from the vacuum generator 32, it draws air from the output of the water pump 2 via a middle passage of the primer valve 30 and via a check valve 34.

The primer valve 30 is operable between pumping and primer modes which will be described more particularly with reference to FIGS. 2 and 3. When the valve 30 is in the pumping mode shown in FIG. 2, the top and middle passages are blocked, so that only recirculating water flows through the valve from the water pump to the water tank. When the valve 30 is in the priming mode, the top and middle passages are open and the bottom passage is blocked. In this condition, air from the air supply circuit is delivered to the vacuum generator 32 via the top passage and vacuum from the vacuum generator draws from the water supply pump 2 via the middle passage to prime the pump. No recirculating water is delivered from the pump 2 to the water tank 8.

The foam supply circuit includes a foam cell 36 in which a foaming agent is stored. Different foaming agents may be stored for producing different types of foam for extinguishing different types of fires. The foaming agents also differ by manufacturer. In order to produce the most efficient fire extinguishing foam, the fire extinguishing apparatus according to the invention is adjustable to alter the characteristics of the foam being produced by the apparatus in accordance with the type of foam agent in the cell 36. A foam injection pump 38 draws foam from the foam cell 36 via check valve 40 and shutoff valve 42. Water from the water pump 2 is delivered to the foam injection pump 38 via a check valve 44 where it mixes with the foaming agent to produce a pressurized water and foam agent mixture.

In order to be suitable for extinguishing fires, the water and foam agent mixture must be aerated by mixing air from the air supply with the foam. This is accomplished by injecting air into the water and foam mixture prior to dispensing the foam from a hose or master stream device. More particularly, the proper flow of air must be mixed with the water and foam mixture to produce the desired foam consistency and properties for extinguishing a particular type of fire.

A balance regulator 44 is connected with the air supply and adjusts the flow of the air supply to match that of the water foam mixture as detected via the line 46. A selector 48 is connected with the output of the balance regulator and includes a plurality of output lines 50, each of which produces a constant flow of air. The central outlet feeds air directly to the water and foam mixture via a check valve 52. However, the remaining two outlet lines feed the constant flow of air to tunable valves 54, 56, respectively, each of which is operable by the operator to adjust the air flow from the respective outlet from the selector. Normally, the tunable valves are adjusted only once to provide a fixed adjustment. Each valve can be adjusted based on the type of foaming agent used in the foam cell so that the proper flow of air is mixed with the water and foam mixture to produce a foam with the desired density and texture based on the type of fire being extinguished. Of course, each valve can be readjusted as necessary. Once the valves 54, 56 are tuned, the operator merely operates the selector to select which of the outputs are used to supply the air flow to the water and foam mixture.

In order to increase the versatility of the device, selectors having a greater number of outputs may be utilized, with additional tunable valves being connected with the additional outputs. It will be appreciated that for a selector having n outputs, n−1 tunable valves are provided, with one of the selector outputs being valve free. The greater the number of outputs and tunable valves, the greater the number of constant air flows are provided.

A secondary foam supply 58 may also be provided if desired. It is connected with the foam cell 36 via the shutoff valve 42. The secondary foam is preferably a mechanical non-air aspirated foam as opposed to a compressed air foam that is mixed with water and air as described above. The secondary foam supply thus allows the device to produce two different types of foam. The secondary foam supply is delivered to a discharge hose, a master stream device, or to a smaller hand line by operation of shutoff valves 62, 64, 66. A shutoff valve 68 is operable to deliver the compressed air foam from the selector 48. A check valve is provided in the line at the output from the valve 60.

The final output of the fire extinguishing apparatus according to the invention is one or more of six products including water, water with wet foaming agent, water with wet foaming agent infiltrated with air, water with wet foaming agent infiltrated with air and dry foaming agent, water with wet foaming agent infiltrated with dry foaming agent, and dry foaming agent. This allows the use of any liquid or dry fire extinguishing or containment agents by controlling both the percent of agent to water as well as the amount of air being utilized to achieve the required consistency at multiple settings as determined by the selector. The selector arrangement allows for variations in foam strengths and properties in accordance with the brands of foaming agent being used. It can easily be tuned for the best performance and consistency of each brand or type of foaming agent. The selector valve allows the operator to return to any preset performance and consistency levels.

The apparatus according to the invention can be used as a stand-alone device or incorporated into a compact vehicle for ease of transport and manueverability.

While the preferred forms and embodiments of the invention have been illustrated and described, it will be apparent to those of ordinary skill in the art that various changes and modifications may be made without deviating from the inventive concepts set forth above.

What is claimed is:

1. A fire extinguishing apparatus, comprising
(a) a foam supply;
(b) an air supply; and
(c) a mixing device connected with said foam and air supplies for mixing air and foam to form a primary air and foam mixture in accordance with the type of fire to be extinguished, said mixing device including an air flow regulator connected with the air supply for controlling the flow of air, said flow regulator including
(i) a selector having a plurality of outputs of constant air flow; and
(ii) at least one adjustable valve connected with one of said selector outputs to adjust the flow from the selector output, whereby the selector may be operated to provide different constant air flows to the mixing device to maximize the efficiency of the primary air and foam mixture in accordance with the type of foam from the foam supply.

2. A fire extinguishing apparatus as defined in claim 1, wherein one of said selector has n outputs and wherein n−1 adjustable valves are connected with said selector outputs, respectively, to provide n constant flows to the mixing apparatus.

3. A fire extinguishing apparatus as defined in claim 2, and further comprising a balance regulator connected with said foam and air supplies to match the pressure of air from the air supply to the pressure of the foam from the foam supply.

4. A fire extinguishing apparatus as defined in claim 1, wherein said foam supply includes a foam injection pump which mixes a foam agent and water.

5. A fire extinguishing apparatus as defined in claim 4, and further comprising a water supply for delivering water to said foam injection pump.

6. A fire extinguishing apparatus as defined in claim 5, wherein said water supply includes a water tank and a recirculating water pump for providing water under pressure to said foam injection pump.

7. A fire extinguishing apparatus as defined in claim 6, and further comprising a primer valve connected with said air supply and said water supply for priming said recirculating water pump.

8. A fire extinguishing apparatus as defined in claim 1, and further comprising a secondary foam supply connected with the output of said mixing device for combining secondary foam with the primary air and foam mixture from said mixing device.
